(19) United States
(12) Patent Application Publication
(10) Pub. No.: US 2008/0137859 A1
(43) Pub. Date: Jun. 12, 2008

(54) PUBLIC KEY PASSING

(76) Inventors: Ramanathan Jagadeesan, San Jose, CA (US); Bryan Ogawa, Sunnyvale, CA (US); Pamela Suzanne Lee, San Jose, CA (US); Mark Enright, Soquel, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/567,619

(22) Filed: Dec. 6, 2006

(51) Int. Cl. H04L 9/08; H04L 9/30; H04K 1/00; G06F 17/00; H04L 9/32

(52) U.S. Cl. 380/270; 380/282; 726/12; 380/258

(57) ABSTRACT

An improved approach to public key passing is provided to inhibit man-in-the-middle (MITM) attacks during an exchange of public keys over one or more public networks. In one embodiment, a method for securely passing public keys includes encrypting a first user public key, wherein the first user public key is associated with a first user device. The method also includes passing the encrypted first user public key to a first gateway server over a secure communication link. The method further includes receiving an encrypted second user public key from the first gateway server over the secure communication link, wherein the second user public key is associated with a second user device, and wherein the second user device is associated with a second gateway server. In addition, the method includes decrypting the second user public key.

### TECHNICAL FIELD

The present disclosure relates generally to public key encryption and authentication.

### BACKGROUND

In order to engage in secure communications over public networks, such as public wireless networks, users may employ various public/private key authentication techniques. In this regard, communications originating from a given user may contain a certificate signed using the sender's private key. The recipient may authenticate the sender by verifying the signature using the sender's public key. Once mutual authentication has taken place, an encrypted communication channel may be established for secure communication.

Such authentication techniques require an initial exchange of public keys between the users. Unfortunately, the exchange of such public keys over public networks can be problematic. In particular, such exchanges can be susceptible to a man-in-the-middle (MITM) attack. In this scenario, a third party may intercept an unencrypted public key initially sent over the network. The third party may then pass its own substitute public key on to the intended recipient of the original unencrypted public key. As a result, the third party may be able to impersonate a user, or gain access to user resources, thereby compromising the security of the public/private key arrangement.

One approach to mitigating such MITM attacks involves the use of trusted third party certificate authorities (CAs) in which a user enrolls with a CA that digitally signs a certificate (e.g., a X.509 certificate) containing a user identifier and public key associated with the user. A recipient may verify the validity of the certificate using the trusted CA's public key and therefore have confidence that a message was indeed sent by the original user. Alternatively, a web of trust model may be used in place of a CA in which a group of trusted parties sign a user's public key certificate to vouch for the authenticity of the user. Unfortunately, these approaches can be unduly burdensome for users who have not already enrolled with a CA or are not presently part of a web of trust.

Another approach is to use a manual out-of-band key fingerprint verification method. In this case, users generate a fingerprint of a public key using a hash after a public key is transmitted between the users. The key may be validated by the users using an out-of-band communication to manually match the fingerprint (e.g., by reading out the hash value during a voice call between the users). Unfortunately, this approach is cumbersome for users lacking the time or facilities to perform such out-of-band validations.

In yet another approach, the domain name service (DNS) system may be used with security extensions and key resource records to provide trusted valid public keys. Unfortunately, this approach also relies on a third party which again may be unduly cumbersome for users to implement.

### BRIEF DESCRIPTION OF THE DRAWINGS

FIG. 1 illustrates a communication system configured to provide public key passing in accordance with an embodiment of the invention.

FIG. 2 illustrates a process of enrolling user devices at gateway servers in accordance with an embodiment of the invention.

FIG. 3 illustrates a process of passing public keys using gateway servers in accordance with an embodiment of the invention.

Like element numbers in different figures represent the same or similar elements.

### DESCRIPTION

### Overview

In accordance with an embodiment of the invention, a method for securely passing public keys includes encrypting a first user public key, wherein the first user public key is associated with a first user device. The method also includes passing the encrypted first user public key to a first gateway server over a secure communication link. The method further includes receiving an encrypted second user public key from the first gateway server over the secure communication link, wherein the second user public key is associated with a second user device, and wherein the second user device is associated with a second gateway server. In addition, the method includes decrypting the second user public key.

In accordance with another embodiment of the invention, a method for securely passing public keys includes receiving an encrypted first user public key from a first user device over a first secure communication link between the first user device and a first gateway server, wherein the first user public key is associated with the first user device. The method also includes decrypting the first user public key. The method further includes passing the first user public key to a second gateway server. In addition, the method includes receiving a second user public key from the second gateway server, wherein the second user public key is associated with a second user device. The method also includes encrypting the second user public key. The method further includes passing the encrypted second user public key to the first user device over the first secure communication link.

In accordance with another embodiment of the invention, an apparatus for securely passing public keys includes means for encrypting a first user public key, wherein the first user public key is associated with a first user device. The apparatus also includes means for passing the encrypted first user public key to a first gateway server over a secure communication link. The apparatus further includes means for receiving an encrypted second user public key from the first gateway server over the secure communication link, wherein the second user public key is associated with a second user device, and wherein the second user device is associated with a second gateway server. In addition, the apparatus includes means for decrypting the second user public key.

In accordance with another embodiment of the invention, an apparatus for securely passing public keys includes means for receiving an encrypted first user public key from a first user device over a first secure communication link between the first user device and a first gateway server, wherein the first user public key is associated with the first user device. The apparatus also includes means for decrypting the first user public key. The apparatus further includes means for passing the first user public key to a second gateway server. In addition, the apparatus includes means for receiving a second user public key from the second gateway server, wherein the second user public key is associated with a second user device. The apparatus also includes means for encrypting the second user public key. The apparatus further includes means for passing the encrypted second user public key to the first user device over the first secure communication link.

These and other features and advantages will be more readily apparent from the description of example embodiments set forth below taken in conjunction with the accompanying drawings.

### Description of Example Embodiments

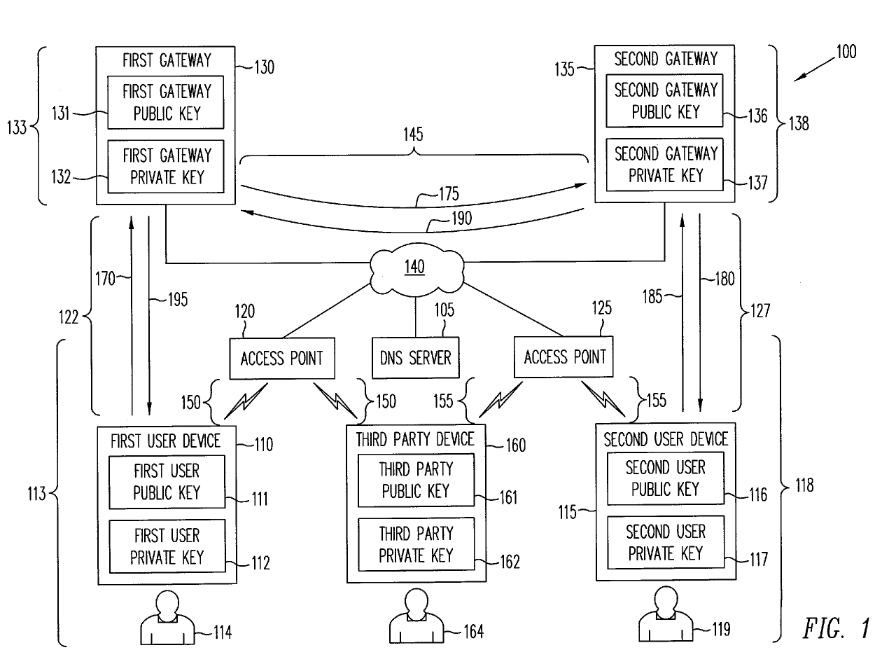

Referring now to the drawings wherein the showings are for purposes of illustrating example embodiments only, and not for purposes of limiting the same, FIG. 1 illustrates a communication system 100 configured to provide public key passing in accordance with an embodiment of the invention. System 100 may be configured to provide user-to-user (U2U) communication between first and second users 114 and 119 through first and second user devices 110 and 115, to permit users 114 and 119 to share resources and information with each other based on dynamic policy. In this regard, communication system 100 may be configured to support key-based authentication between first and second user devices 110 to verify user identities and apply appropriate access control policies.

As shown, system 100 may include first and second user devices 110 and 115, first and second access points 120 and 125, first and second gateway servers 130 and 135, and a domain name service (DNS) server 105, all of which may be configured to communicate over a network 140. Network 140 may be implemented with one or more sub-networks. For example, in various embodiments, network 140 may include the Internet or one or more intranets, landline networks, wireless networks, and/or other types of networks known in the art.

DNS server 105 may be implemented as a conventional domain name service server which may provide appropriate clients such as gateway servers 130 and 135, access points 120 and 125, and user devices 110 and 115 with appropriate Internet Protocol (IP) address information in response to requests from such clients.

As shown, first and second user devices 110 and 115 may be associated with first and second users 114 and 119, and may be implemented as any appropriate devices configured for wired and/or wireless communication over network 140 and/or wireless networks 150 and 155. For example, in the case of wireless communication, first and second user devices 110 and 115 may be implemented as wireless telephones, personal digital assistants (PDAs), notebook computers, and/or other mobile user devices which may be configured for wireless electronic communication through, for example, the session initiation protocol (SIP).

In the embodiment illustrated in FIG. 1, first and second user devices 110 and 115 are in wireless communication with first and second access points 120 and 125 through first and second wireless networks 150 and 155, respectively. As a result, first and second user devices 110 and 115 may communicate with first and second gateway servers 130 and 135 through network 140. In one embodiment, user devices 110 and 115, wireless networks 150 and 155, and access points 120 and 125 may be configured to support one or more wireless protocols such as IEEE 802.11a, b, or g, or any other desired wireless protocol, such as Bluetooth. However, it will be appreciated that in other embodiments first and second user devices 110 and 115 may be connected directly to network 140 in place of access points 120 and 125 if desired.

First and second user devices 110 and 115 may be located in range of any appropriate public or private wireless networks 150 and 155. For example, in one embodiment, first user device 110 may be located with first user 114 and access point 120 at a first public location 113. Similarly, second user device 115 may be located with second user 119 and access point 125 at a second public location 118. In another embodiment, user devices 110 and 115 and first and second users 114 and 119 may be co-located and in range of one of wireless networks 150 or 155 and one of access points 120 or 125.

First and second gateway servers 130 and 135 may be positioned at locations 133 and 138, respectively, from which they may communicate with network 140. In one embodiment, locations 133 and 138 may be secure locations, such as a private residence or place of business of first user 114 and of second user 119, respectively.

Gateway servers 130 and 135 may be implemented to facilitate secure communication links 122 and 127 with user devices 110 and 115 through network 140, access points 120 and 125, and wireless networks 150 and 155. Secure communication links 122 and 127 may be implemented using various cryptography methods. For example, in various embodiments, secure communication links 122 and 127 may be implemented as encrypted tunnels using appropriate Internet Protocol Security (IPSec) or transport layer security (TLS) protocols with Advanced Encryption Standard (AES) or Triple Data Encryption Standard (3DES) encryption, for example. In this regard, first user device 110 may have an associated first user public key 111 and an associated first user private key 112. Similarly, second user device 115 may have an associated second user public key 116 and an associated second user private key 117. First gateway server 130 may have an associated first gateway public key 131 and an associated first gateway private key 132. Similarly, second gateway server 135 may have an associated second gateway public key 136 and an associated second gateway private key 137.

First user device 110 and first gateway server 130 may exchange their associated public keys 111 and 131, respectively, to permit each to encrypt communications using the other's public key. Such encrypted communications may be decrypted when received using the receiving entity's associated private key 112 or 132. As a result, a secure communication link 122 may be established between first user device 110 and first gateway server 130 through wireless network 150, access point 120, and network 140 as indicated shown in FIG. 1. It will be appreciated that another secure communication link 127 may be established between second user device 115 and second gateway server 135 through a similar exchange and encryption using public keys 116 and 136, and decryption using private keys 117 and 137.

First and second gateway servers 130 and 135 may communicate with each other over network 140 through an appropriate communication link 145. Communication link 145 may be implemented as a secure or non-secure communication link. For example, in one embodiment, communications received by first and second gateway servers 130 and 135 from first and second user devices 110 and 115, respectively, may be passed between first and second gateway servers 130 and 135 over communication link 145 as unencrypted communications. In another embodiment, first and second gateway servers 130 and 135 may pass encrypted communications over communication link 145 through the exchange of public keys 131 and 136, certificates, or other encryption methods. Various approaches may be used to distribute keys between first and second gateway servers 130 and 135. For example, in one embodiment, first and second gateway servers 130 and 135 may be configured to support Domain Name System Security Extensions (DNSSEC). Accordingly, in this embodiment, first and second gateway servers 130 and 135 may publish their associated public keys 131 and 136 to DNS server 105.

FIG. 1 further illustrates a third party device 160 associated with a third party user 164. As shown, third party device 160 may be in wireless communication with access point 120 and/or 125 through wireless network 150 and/or 155, respectively. Third party device 160 may also have an associated third party public key 161 and an associated third party private key 162. In the event that user devices 110 and 115 desire to communicate with each other over wireless networks 150 and 155, third party device 160 may attempt to perform a man-in-the-middle (MITM) attack. In this regard, if first user device 110 attempts to pass first user public key 111 to second user device 115 through wireless network 150, third party device 160 may attempt to intercept the communication and pass third party public key 161 on to second user device 115 instead. It will be appreciated that third party device 160 may attempt to intercept and replace second user public key 116 in a similar fashion.

However, it will be appreciated that in the arrangement set forth in FIG. 1, communications of each of first and second user devices 110 and 115 may be routed through first and second gateway servers 130 and 135, respectively, over secure communication links 122 and 127 established by first and second user devices 110 and 115 with their associated first and second gateway servers 130 and 135, respectively. As a result, third party device 160 will be prevented from intercepting public key information exchanged by first and second user devices 110 and 115 over wireless networks 150 and 155. Advantageously, this arrangement can facilitate the sharing of private communications between first and second user devices 110 and 115, even when such devices are accessing wireless networks in public locations 113 and 118.

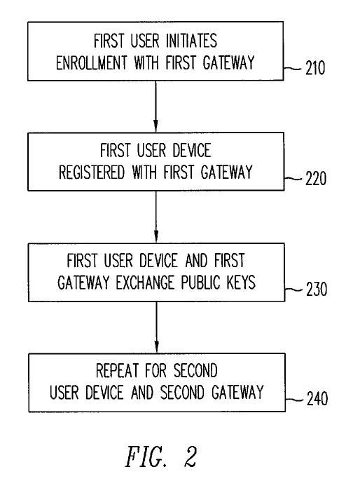

FIG. 2 illustrates a process of enrolling user devices 110 and 115 at gateway servers 130 and 135 in order to facilitate the establishment of secure communication links 122 and 127, respectively, in accordance with an embodiment of the invention. It will be appreciated that prior to establishing secure communication links 122 and 127, first and second user devices 110 and 115 may not have yet exchanged public keys with first and second gateway servers 130 and 135, respectively.

In this regard, during the process of FIG. 2, first user 114 and first user device 110 may be temporarily positioned in physical proximity with first gateway server 130 to engage in private communications with first gateway server 130, such as at private location 133. For example, first user device 110 may be connected directly with first gateway server 130 to prevent inadvertent wireless transmission of public key information to other parties. It will be appreciated that second user 119 and second user device 115 may be similarly temporarily positioned in physical proximity with second gateway server 135, such as at private location 138 to engage in private communications during the process of FIG. 2.

In step 210, first user 114 initiates enrollment with first gateway server 130. This may include, for example, sending a request from first user device 110 to first gateway server 130. Then, in step 220, first gateway server 130 registers first user device 110. In various embodiments, step 220 may be performed in accordance with any appropriate registration method. For example, such registration methods may be implemented using Cisco Simple Certificate Enrollment Protocol (SCEP), Universal Plug and Play (UPnP), software available from DARTdevices Corporation, and/or registration methods that allow for device discovery and provide a pairing mechanism to register first user device 110 (e.g., using an appropriate user identifier) with first gateway server 130. In another embodiment, step 220 may be performed using an appropriate push-button wireless registration method.

Following the registration performed in step 220, first user device 110 and first gateway server 130 exchange public keys in step 230. For example, in one embodiment, first gateway server 130 may generate its own private/public key pair and create a self-signed certificate containing its public key in step 230. Steps 210 through 230 may then be repeated for second user 119, second user device 115, and second gateway server 135 at private location 138. Accordingly, it will be appreciated that following the process of FIG. 2, first and second user devices 110 and 115 may establish secure communication links 122 and 127 with first and second gateway servers 130 and 135, respectively, through various encryption methods.

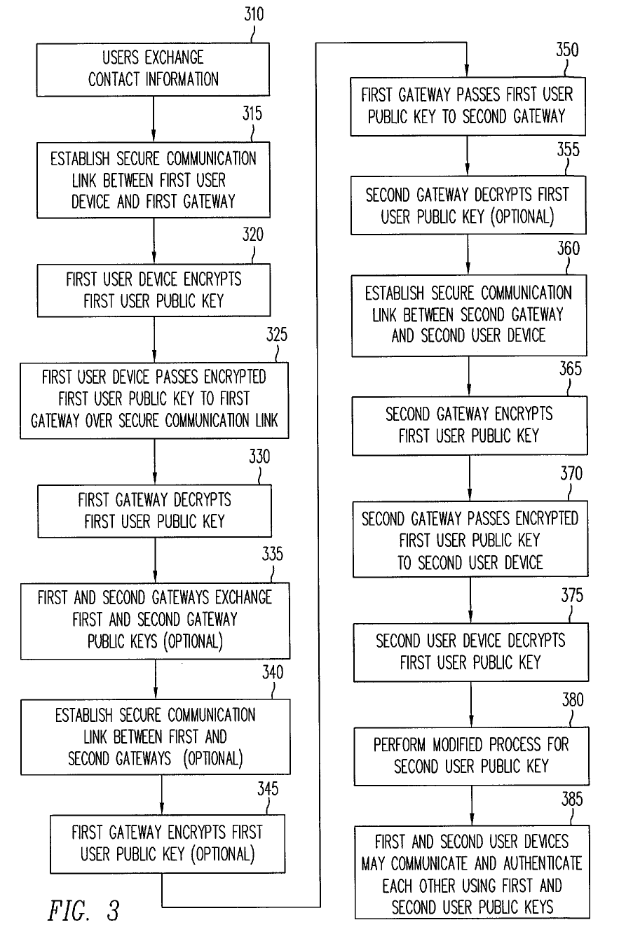

FIG. 3 illustrates a process of passing public keys using gateway servers 130 and 135 in accordance with an embodiment of the invention. The process of FIG. 3 may be performed after first and second user devices 110 and 115 register with first and second gateway servers 130 and 135 in accordance with the process of FIG. 2.

In step 310, first user 114 and second user 119 exchange contact information. For example, in one embodiment, first and second users 114 and 119 may provide each other with an SIP-compatible address of record (AoR) such as an email address, uniform resource identifier (URI), user identifier, or other identifier that may be associated with first or second gateway servers 130 and 135. Such an exchange may be performed through an out-of-band communication (such as a telephone conversation or in-person meeting), one or more electronic communications, or other methods. Subsequently, in steps 315 through 380, first and second users 114 and 119 may securely exchange public keys through wireless networks 150 and 155 in order to facilitate further secure communications in step 385.

It will be appreciated that because of the prior registration of first user device 110 with first gateway server 130 in the process of FIG. 2, communications between first user device 110 and first gateway server 130 may be encrypted using various encryption methods. Accordingly, first user device 110 may establish secure communication link 122 with first gateway server 135 in step 315, and encrypt first user public key 111 in step 320. In this regard, the encryption performed in step 320 may be provided as part of secure communication link 122 or may be provided in addition to secure communication link 122. Similarly, it will be appreciated that the encryption subsequently performed in steps 345 and/or 365 may be provided as part of secure communication links 145 and/or 127, respectively.

In step 325, first user device 110 passes first user public key 111 (which is now encrypted) to first gateway server 130 over secure communication link 122 and over wireless network 150 and network 140 as shown by arrow 170 of FIG. 1. Upon receipt of the encrypted first user public key 111, first gateway server 130 decrypts first user public key 111 in step 330.

As previously described in relation to FIG. 1, communication link 145 between first and second gateway servers 130 and 135 may be optionally implemented as a secure communication link through various encryption methods. In this regard, the embodiment set forth in FIG. 3 illustrates the use of optional steps to implement such secure communications between first and second gateway servers 130 and 135.

In optional step 335, first and second gateway servers 130 and 135 may exchange public keys 131 and 136. Then, in optional step 340, first gateway server 130 establishes secure communication link 145 with second gateway server 135. In optional step 345, first gateway server 130 encrypts first user public key 111 to be sent over secure communication link 145.

In step 350, first gateway server 130 passes first user public key 111 (which may be in an encrypted form in response to optional previous step 345) to second gateway server 135 over network 140 as shown by arrow 175 of FIG. 1. In this regard, it will be appreciated that first and second gateway servers 130 and 135 may be registered with DNS server 105 to route messages sent to a given user identifier on to a URI associated with each gateway server.

In optional step 355, second gateway server 135 decrypts first user public key 111 (which may be in an encrypted form in response to optional previous step 345). In step 360, second gateway server 135 establishes secure communication link 127 with second user device 115. Second gateway server 135 then encrypts first user public key 111 in step 365 and passes the encrypted first user public key 111 to second user device 115 in step 370 as shown by arrow 180 of FIG. 1. Then, in step 375, second user device 115 decrypts first user public key 111.

In step 380, the process of steps 315 through 330 and steps 340 through 375 may be repeated in a modified form to provide second user public key 116 to first user device 110 as shown by arrows 185, 190, and 195 of FIG. 2. In this regard, second user device 115 may establish secure communication link 127 with second gateway server 135, encrypt second user public key 116, and pass the encrypted second user public key 116 to second gateway server 135 over secure communication link 127 and over wireless network 155 and network 140 as shown by arrow 185 of FIG. 1. Second gateway server 135 may then decrypt second user public key 116, may optionally establish secure communication link 145 with first gateway server 130, may optionally encrypt second user public key 116, and then pass second user public key 116 (which may optionally be in an encrypted form) to first gateway server 130 over communication link 145 and network 140 as shown by arrow 190 of FIG. 1.

Also in step 380, first gateway server 130 may optionally decrypt second user public key 116. First gateway server 130 may establish secure communication link 122 with first user device 110, encrypt second user public key 116, and then pass second user public key 116 (which is now encrypted) to first user device 110 over secure communication link 122 and over network 140 and wireless network 150 as shown by arrow 195 of FIG. 1. First user device 110 may then decrypt second user public key 116.

It will be appreciated that following step 380, first and second user devices 110 and 115 will have received public keys from each other. Accordingly, in step 385, first and second user devices 110 and 115 may communicate with each other using public key authentication facilitated by public keys 111 and 116. For example, first and second user devices 110 and 115 may sign communications with their associated first and second user private keys 112 and 117, respectively, and authenticate such communications using the other device's associated public key which was exchanged pursuant to the process of FIG. 3. In this regard, messages sent by users 114 and 119 may be securely transmitted through wireless networks 150 and 155 and routed through first and second gateway servers 130 and 135 if desired. Moreover, because the prior exchange of public keys 111 and 116 between user devices 110 and 115 was performed using encrypted communications through first and second gateways 130 and 135, MITM attacks by third party 164 through third party device 160 may be thwarted.

In view of the present disclosure, it will be appreciated that various features set forth herein can provide significant improvements to the passing of public keys over non-secure public networks. In particular, by encrypting and passing public keys through associated gateway servers, the risk of MITM attacks occurring over non-secure public wireless networks can be reduced. Advantageously, such an approach also allows users to avoid the costs and complexities associated with centralized certificate authorities and out-of-band user verification and key exchange methods while still maintaining a desirable level of security during public key passing in public networks.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as program code and/or data, can be stored on one or more computer readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

What is claimed is:

1. A method for securely passing public keys, the method comprising:
encrypting a first user public key, wherein the first user public key is associated with a first user device;
passing the encrypted first user public key to a first gateway server over a secure communication link;
receiving an encrypted second user public key from the first gateway server over the secure communication link, wherein the second user public key is associated with a second user device, and wherein the second user device is associated with a second gateway server; and
decrypting the second user public key.

2. The method of claim 1, wherein the passing comprises transmitting the encrypted first user public key to an access point over a wireless network.

3. The method of claim 2, wherein the wireless network is a public network.

4. The method of claim 1, wherein the method is performed by the first user device in a public location.

5. The method of claim 1, wherein the first user device is a mobile telephone.

6. The method of claim 1, further comprising:
signing a first communication using a first user private key associated with the first user device, wherein the first communication is intended for the second user device; and
passing the first communication to the first gateway server over the secure communication link.

7. The method of claim 6, further comprising:
receiving a second communication from the first gateway server over the secure communication link, wherein the second communication is signed by a second user private key associated with the second user device, wherein the second communication is intended for the first user device; and
authenticating the second communication using the second user public key.

8. The method of claim 1, further comprising exchanging the first user public key and a gateway public key between the first user device and the first gateway server, wherein the gateway public key is associated with the first gateway server.

9. A method for securely passing public keys, the method comprising:
receiving an encrypted first user public key from a first user device over a first secure communication link between the first user device and a first gateway server, wherein the first user public key is associated with the first user device;
decrypting the first user public key;
passing the first user public key to a second gateway server;
receiving a second user public key from the second gateway server, wherein the second user public key is associated with a second user device;
encrypting the second user public key; and
passing the encrypted second user public key to the first user device over the first secure communication link.

10. The method of claim 9, wherein the passing the first user public key comprises passing the first user public key to the second gateway server over a second secure communication link.

11. The method of claim 10, further comprising exchanging a first gateway public key and a second gateway public key between the first gateway server and the second gateway server, wherein the first gateway public key is associated with the first gateway server, and the second gateway public key is associated with the second gateway server.

12. The method of claim 9, wherein the method is performed by the first gateway server in a private location associated with a user of the first user device.

13. The method of claim 9, further comprising:
receiving a first communication from the first user device over the first secure communication link, wherein the first communication is signed by a first user private key associated with the first user device, wherein the first communication is intended for the second user device; and
passing the first communication to the second gateway server.

14. The method of claim 13, further comprising:
receiving a second communication from the second gateway server, wherein the second communication is signed by a second user private key associated with the second user device, wherein the second communication is intended for the first user device; and
passing the second communication to the first user device over the first secure communication link.

15. The method of claim 9, further comprising exchanging the first user public key and a first gateway public key between the first user device and the first gateway server, wherein the first gateway public key is associated with the first gateway server.

16. An apparatus for securely passing public keys, the apparatus comprising:
means for encrypting a first user public key, wherein the first user public key is associated with a first user device;
means for passing the encrypted first user public key to a first gateway server over a secure communication link;
means for receiving an encrypted second user public key from the first gateway server over the secure communication link, wherein the second user public key is associated with a second user device, and wherein the second user device is associated with a second gateway server; and
means for decrypting the second user public key.

17. The apparatus of claim 16, further comprising:
means for signing a first communication using a first user private key associated with the first user device, wherein the first communication is intended for the second user device;
means for passing the first communication to the first gateway server over the secure communication link;
means for receiving a second communication from the first gateway server over the secure communication link, wherein the second communication is signed by a second user private key associated with the second user device, wherein the second communication is intended for the first user device; and
means for authenticating the second communication using the second user public key.

18. An apparatus for securely passing public keys, the apparatus comprising:
means for receiving an encrypted first user public key from a first user device over a first secure communication link between the first user device and a first gateway server, wherein the first user public key is associated with the first user device;
means for decrypting the first user public key;
means for passing the first user public key to a second gateway server;
means for receiving a second user public key from the second gateway server, wherein the second user public key is associated with a second user device;
means for encrypting the second user public key; and
means for passing the encrypted second user public key to the first user device over the first secure communication link.

19. The apparatus of claim 18, further comprising:
means for encrypting the first user public key; and
means for passing the encrypted first user public key to the second gateway server over a second secure communication link.

20. The apparatus of claim 18, further comprising:
means for receiving a first communication from the first user device over the first secure communication link, wherein the first communication is signed by a first user private key associated with the first user device, wherein the first communication is intended for the second user device;
means for passing the first communication to the second gateway server;
means for receiving a second communication from the second gateway server, wherein the second communication is signed by a second user private key associated with the second user device, wherein the second communication is intended for the first user device; and
means for passing the second communication to the first user device over the first secure communication link.
